(19) United States
(12) Patent Application Publication
(10) Pub. No.: US 2012/0081529 A1
(43) Pub. Date: Apr. 5, 2012

(54) METHOD OF GENERATING AND REPRODUCING MOVING IMAGE DATA BY USING AUGMENTED REALITY AND PHOTOGRAPHING APPARATUS USING THE SAME

(75) Inventor: Kyung-yul SEO, Iksan-si (KR)

(73) Assignee: Samsung Electronics Co., Ltd, Suwon-si (KR)

(21) Appl. No.: 13/242,683

(22) Filed: Sep. 23, 2011

(30) Foreign Application Priority Data
Oct. 4, 2010 (KR) 10-2010-0096505

(51) Int. Cl. H04N 7/18

(52) U.S. Cl. 348/61; 348/E07.085

(57) ABSTRACT

A method of generating and reproducing moving image data by using augmented reality (AR) and a photographing apparatus using the method includes features of capturing a moving image, receiving augmented reality information (ARI) of the moving image, and generating a file including the ARI while simultaneously recording the captured moving image. Accordingly, when moving image data is recorded, an ARI file including ARI is also generated, thereby providing an environment in which the ARI is usable when reproducing the recorded moving image data.

### CROSS-REFERENCE TO RELATED APPLICATIONS

This application claims priority under 35 U.S.C. §119(a) from Korean Patent Application No. 10-2010-0096505, filed on Oct. 4, 2010, in the Korean Intellectual Property Office, the disclosure of which is incorporated herein by reference in its entirety.

### BACKGROUND

1. Field of the Invention

The present general inventive concept generally relates to a method of generating and reproducing moving image data by using an augmented reality (AR) and a photographing apparatus using the same, and more particularly, to a method of generating and reproducing moving image data including augmented reality information (ARI) and a photographing apparatus using the same.

2. Description of the Related Art

Augmented reality (AR) refers to a technique by which a virtual object overlaps a real environment and then is displayed to a user. For example, when a virtual object overlaps a real environment seen through a camera and then is displayed, a user recognizes the virtual object as a part of a real world. If AR is used, a 3-dimensional (3-D) virtual object overlaps a real image displayed to a user to obscure a distinction between a real environment and a virtual screen so as to provide a realistic image.

As portable devices having photographing functions, including a smart phone, devices to which AR is applied have been commercialized. In other words, a virtual object overlaps a still-image that a user actually photographs, and is then displayed through a display unit of a portable device having a photographing function, including a smart phone. Here, the virtual object may correspond to text information regarding information on a building, a human, or an animal, image information, or the like.

Also, virtual objects included in an AR image are displayed when the AR image is actually photographed. If the virtual objects are touched or clicked, touched or clicked information is accessed or related information is further displayed to provide convenience to a user.

However, if an AR image is recorded, only one of a real image or only a virtual object is recorded as an image. Therefore, if the recorded image is reproduced later, another type of information cannot be accessed or related information cannot be further displayed by clicking or touching the virtual object.

### SUMMARY

The present general inventive concept provides a method of generating and reproducing moving image data by which, when recording moving image data, an augmented reality information (ARI) file including ARI is also generated so as to use the ARI even when reproducing the recorded moving image data, and a photographing apparatus using the same.

Additional exemplary embodiments of the present general inventive concept will be set forth in part in the description which follows and, in part, will be obvious from the description, or may be learned by practice of the present general inventive concept.

The foregoing and/or other features and utilities of the present general inventive concept may be achieved by a method of generating moving image data, the method including capturing a moving image, receiving augmented reality information (ARI) of the moving image, and generating a file including the ARI with recording the captured moving image.

The method may further include inserting the file including the ARI into data of the captured moving image.

The ARI may be divided on a tag basis and may be tag information which includes information seen in an augmented reality (AR) and reproduction information necessary to reproduce the moving image data.

The information seen in the AR may include at least one of global positioning system (GPS) coordinates, gyro (G) sensor information, temperature information, user-defined information, a date at which the moving image has been acquired, and general information regarding the moving image, and the reproduction information may include one of an area and a coordinate in which a reproducing apparatus is touchable when reproducing the moving image data.

The ARI may include identification (ID) information which is generated through arbitrary combinations of the GPS coordinates, the G sensor information, the temperature information, the user-defined information, the date at which the moving image has been acquired, and the general information regarding the moving image.

The ARI may be received at preset time intervals.

Web information related to detailed information may include text information regarding the moving image, still image information, and moving image information.

The ARI may be received by wireless through a wireless network or by wire through a storage device which stores information related to the captured moving image.

The file including the ARI may be a file which is made and generated by a user.

A file name of the file including the ARI may be equal to a file name of the captured moving image data.

The foregoing and/or other features and utilities of the present general inventive concept may also be achieved by a method of reproducing moving image data, the method including searching for an ARI file including ARI of a moving image, and executing the searched ARI file with displaying the moving image.

The ARI may be divided on a tag basis and may be tag information which includes information seen in an AR and reproduction information necessary to reproduce data included with the moving image.

The information seen in the AR may include at least one of GPS coordinates, G sensor information, temperature information, user-defined information, a date at which the moving image has been acquired, and general information regarding the moving image, and the reproduction information may include one of an area and a coordinate in which a reproducing apparatus is touchable when reproducing the moving image data.

The ARI may include ID information which is generated through arbitrary combinations of the GPS coordinates, the G sensor information, the temperature information, the user-defined information, the date at which the moving image has been acquired, and the general information regarding the moving image.

The ARI may be information to search for detailed information of the moving image and may be information to access web information related to the detailed information.

The web information related to the detailed information may include text information of the moving image, still image information, and moving image information.

The moving image data into which the ARI has been inserted may be received by wireless through a wireless network or by wire through a storage device.

The display of the moving image may include overlapping and displaying the ARI with the moving image data through On Screen Display (OSD).

The method may further include receiving a request to access the detailed information of the moving image through the ARI from a user, wherein if the request is received, the detailed information which is related to the moving image and exists on a website is accessed to be displayed to the user.

The detailed information which is related to the moving image and accessed through the ARI may be at least one of text information, still image information, and moving image information.

If the request is received, a reproduction of a currently displayed moving image data may be ended, and the detailed information which is accessed through the ARI and related to the moving image may be displayed.

If the request is received, a reproduction of a currently displayed moving image data may be paused, and the accessed detailed information related to the moving image may be displayed as a picture-in-picture (PIP) image.

The foregoing and/or other features and utilities of the present general inventive concept may also be achieved by a photographing apparatus, including a photographing unit to capture a moving image, a receiver to receive ARI of the moving image, and a controller to generate a file including the ARI with recording the captured moving image.

The controller may insert the file including the ARI into data into the captured moving image to generate a file.

The ARI may be divided on a tag basis and may be tag information which includes information seen in an AR and reproduction information necessary to reproduce the moving image data.

The information seen in the AR may include at least one of GPS coordinates, G sensor information, temperature information, user-defined information, a date at which the moving image has been acquired, and general information regarding the moving image, and the reproduction information may include one of an area and a coordinate in which a reproducing apparatus is touchable when reproducing the moving image data.

The ARI may include ID information which is generated through arbitrary combinations of the GPS coordinates, the G sensor information, the temperature information, the user-defined information, the date at which the moving image has been acquired, and the general information regarding the moving image.

A file name of the file including the ARI may be equal to a file name of the captured moving image data.

Web information related to detailed information may include text information related to the moving image, still image information, and moving image information.

The receiver may receive the moving image data, into which the ARI is inserted, by wireless through a wireless network or by wire through a storage device.

The photographing apparatus may further include a display unit to execute and display an ARI file along with the moving image data.

The display unit may overlap and display the ARI with the moving image data through an OSD.

The photographing apparatus may further include an input unit to receive a request for information related to the moving image from a user, wherein if the request of the user is received from the input unit, the display unit accesses the detailed information, which is related to the moving image and exists on a website, to display the detailed information to the user.

The input unit may be a touch pad which is provided on the display unit.

The detailed information which is related to the moving image and accessed through the ARI may be at least one of text information, still image information, and moving image information.

If the request of the user is received from the input unit, the display unit may end a reproduction of a currently displayed moving image data and display the detailed information which is accessed through the ARI and related to the moving image.

If the request of the user is received from the input unit, the display unit may pause a reproduction of a currently displayed moving image data and display the accessed detailed information related to the moving image as a PIP image.

The photographing apparatus may include one of a camera, camcorder, a smart phone, and a tablet personal computer (PC).

In another feature of the present general inventive concept, a photographing apparatus, comprises a display screen to display moving image data including a real image and at least one virtual object, and a control module to generate and display detailed information of the real image in response to manipulating the at least one virtual object.

In yet another feature of the present general inventive concept, a photographing apparatus comprises a display screen to display moving image data thereon, and a control module to read a data file comprising moving image data and ARI data and to reproduce the moving image data on the display screen along with at least one virtual object linked to a real image displayed in the moving image data, wherein the control module displays detailed information based on the ARI data of the data file in response to selecting the virtual object.

In still another feature of the present general inventive concept, a photographing apparatus comprises a photographing unit to record a captured moving image, a storage unit to store first information therein, and a controller to determine second information from the capture moving image, to generate a combined ARI based on the first information stored in the storage unit and the second information from the captured moving image, and to generate a data file comprising the combined ARI while recording the captured moving image.

### BRIEF DESCRIPTION OF THE DRAWINGS

These and/or other embodiments of the present general inventive concept will become apparent and more readily appreciated from the following description of the embodiments, taken in conjunction with the accompanying drawings of which:

FIG. 1 is a block diagram illustrating a method of generating moving image data according to an exemplary embodiment;

FIG. 2 is a block diagram illustrating a method of generating moving image data according to another exemplary embodiment;

FIG. 3 is a block diagram illustrating a method of generating moving image data according to another exemplary embodiment;

FIGS. 4A and 4B are views illustrating a method of generating moving image data according to an exemplary embodiment;

FIGS. 5A and 5B are views illustrating a method of generating moving image data according to an exemplary embodiment;

FIGS. 6A and 6B are views illustrating a method of reproducing moving image data according to an exemplary embodiment;

FIGS. 7A through 7F are views illustrating a method of reproducing moving image data according to an exemplary embodiment;

FIG. 8 is a view illustrating a format of maintaining an identity of a recorded moving image according to an exemplary embodiment;

FIGS. 9A through 9D are views illustrating a method of generating and reproducing moving image data according to another exemplary embodiment;

FIG. 10 is a flowchart illustrating a method of generating moving image data according to an exemplary embodiment;

FIG. 11 is a flowchart illustrating a method of reproducing moving image data according to an exemplary embodiment; and

FIG. 12 is a block diagram illustrating a structure of a photographing apparatus according to an exemplary embodiment.

### DETAILED DESCRIPTION OF THE EMBODIMENTS

Reference will now be made in detail to exemplary embodiments of the present general inventive concept, examples of which are illustrated in the accompanying drawings, wherein like reference numerals refer to like elements throughout. The exemplary embodiments are described below in order to explain the present general inventive concept by referring to the figures.

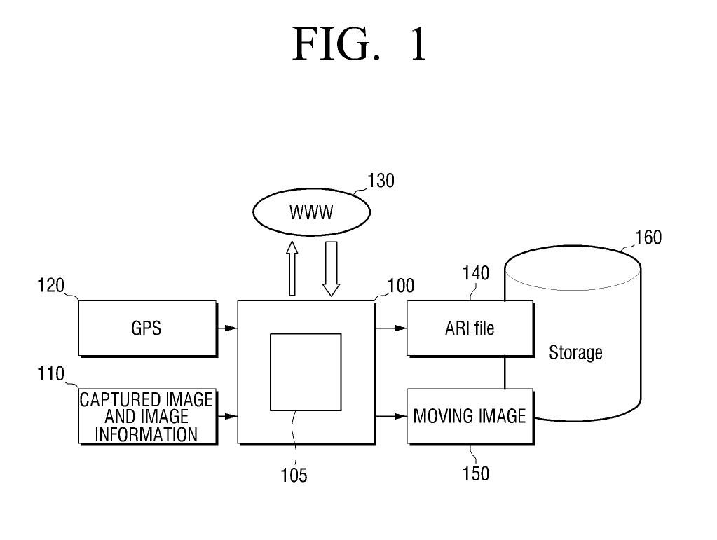

FIG. 1 is a block diagram illustrating a method of generating moving image data according to an exemplary embodiment. A photographing apparatus 100 receives a captured moving image and image information 110 through a photographing unit (not shown) and location information through a global positioning system (GPS) 120. The captured moving image may include a stationary object captured with respect to the movement of photographing apparatus 100 and/or may include a moving object captured with respect to a photographing apparatus 100 existing in a stationary position. The photographing apparatus 100 includes a controller 105 that may collect basic information regarding the captured image, such as a location and/or a captured date of the captured moving image, through the received image and location information. The photographing apparatus 100 further receives information regarding the captured image through a network 130 based on the received captured moving image and location information. In other words, the photographing apparatus 100 may obtain information regarding subjects included in the captured moving image, e.g., information regarding a building, a person, etc., based on the location information received through the GPS and the captured image. Hereinafter, such information will be referred to as augmented reality information (ARI). Upon capturing the moving image, the moving image data 150 may be generated and stored in a storage unit 160, as discussed in greater detail below.

In other words, the ARI may be link information to request and/or to access detailed information regarding a subject included in a captured moving image based on an augmented reality (AR). The detailed information 505-1 may include, but is not limited to, text, hyperlinks, still images, moving images and sound.

Upon obtaining the ARI, an ARI file 140 may be automatically generated based on the ARI. A file name of the ARI file 140 may be equal to a file name of captured moving image data 150. Therefore, the ARI file 140 may be executed together when the captured moving image data 150 is reproduced. Alternatively, the ARI file 140 may be inserted into the moving image data 150.

The moving image data 150, the ARI file 140, and the combined moving image data 150 into which the ARI file 140 has been inserted are stored in a storage unit 160. Accordingly, a user can use the ARI even when reproducing the moving image data 150.

The ARI may be divided into various tags comprising tag information 214, which includes information seen in an AR. Additionally, the ARI, may include reproduction information necessary to reproduce moving image data 150. In more detail, the information seen in the AR may include at least one of GPS coordinates, gyro (G) sensor information, temperature information, user-defined information, a date at which the captured image has been acquired, and general information regarding the captured image. Accordingly, the tags may be generated to correspond with the respective information seen in the AR. The reproduction information may be an area and a coordinate on a display unit 155 of the reproducing apparatus in which a reproducing apparatus is touchable when reproducing the moving image data 150.

The ARI may also include identification (ID) information which is generated through combinations of the GPS coordinates, the G sensor information, the temperature information, the user-defined information, the date at which the captured image has been acquired, and the general information regarding the captured image. If the user requests the ARI when reproducing the moving image data 150, i.e., the user selects, for example touches and/or clicks, the ARI included in moving image data 150, the user may be linked to the corresponding ARI. As described above, the ARI may be regarded as information to search for detailed information of an object included in a moving image and information to access web information related to the detailed information. The web information related to the detailed information may include, but is not limited to, text information regarding an object of moving image data, still image information, and moving image information.

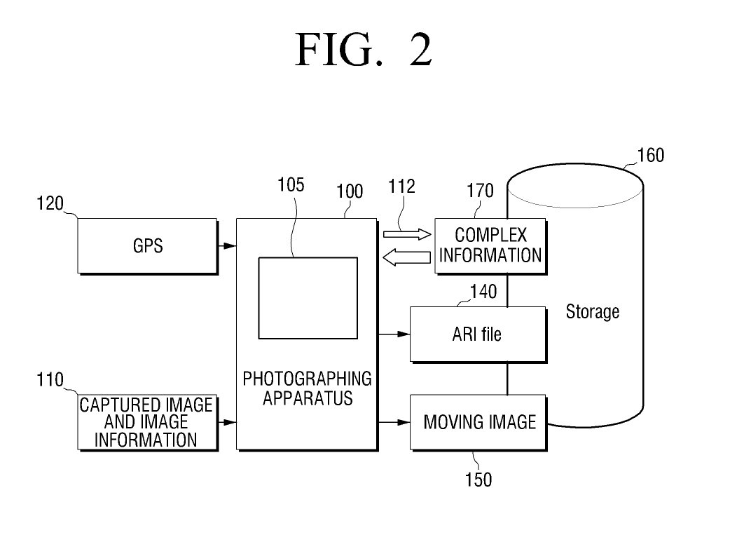

FIG. 2 is a block diagram illustrating a method of generating moving image data according to another exemplary embodiment. The photographing apparatus 100 includes a storage unit 160 that may pre-store complex information 170 to be used to generate an ARI of a captured moving image. For example, the complex information 170 may include current GPS data, pre-stored names of places, people, etc. Further, the complex information 170 may be information generated by a user and then stored in the storage unit 160. A photographing apparatus 100 receives a captured image and image information 110 through a photographing unit and location information through a GPS 120.

The controller 105 of the photographing apparatus 100 collects basic information 112 regarding the captured image, such as a location and/or a captured date of the captured image, based on the received image and location information. The controller 105 of the photographing apparatus 100 combines the basic information 112 with pieces of complex information 170 pre-stored in a storage unit 160 to form ARI regarding the captured image, based on the received image and location information. Upon forming the ARI, an ARI file 140 may be automatically generated. In other words, the controller 105 of the photographing apparatus 100 obtains ARI regarding subjects included in the captured image, e.g., ARI regarding a building, a person, etc., based on the basic location information 112 received through the GPS 120 and the captured image, and complex information 170 pre-stored in the storage unit 160. The ARI obtained as described above is generated as an ARI file 140 and/or is inserted into moving image data 150 and then stored in the storage unit 160.

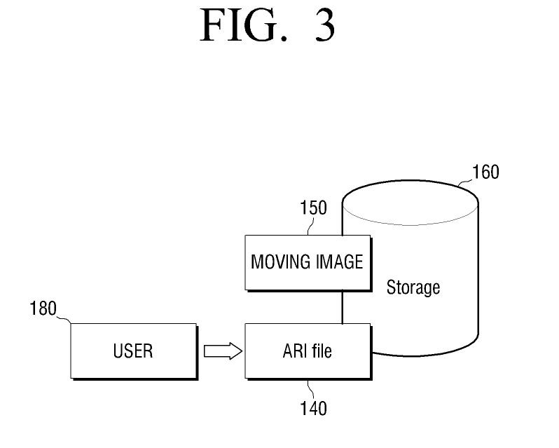

FIG. 3 is a block diagram illustrating a method of generating moving image data according to another exemplary embodiment. Unlike the exemplary embodiments of FIGS. 1 and 2 where the ARI file 140 is generated automatically by the controller 105 of the photographing apparatus 100, in the case of the exemplary embodiment of FIG. 3, an ARI file 140 is generated by a user 180. More specifically, a user of the photographing apparatus 100 may generate an ARI file 140 having the same file name as moving image data 150. Accordingly, the user-generated ARI file 140 may be directly inserted into the moving image data 150. In other words, the user 180 may arbitrarily create tags to generate the ARI file 140, as opposed to using ARI which is generated through information collected through a GPS or a web.

In the case where the user generates the ARI file 140, when the moving image data 150 is reproduced, the ARI file 140 having the same file name as the moving image data 150 is executed together. If there is a request of the user 180 for information related to the moving image data 150, a website to which a maker of the ARI file 140 desires to be linked may be accessed, a current screen may be changed to a screen desired by the user 180, or texts or a moving image that the user 180 desires to display may be displayed. The moving image data 150 including the ARI file 140 is stored in a storage unit 160.

FIGS. 1 through 3 illustrate the methods of generating moving image data according to exemplary embodiments. However, the present general inventive concept is not limited to the embodiments illustrated in FIGS. 1 through 3. In other words, the moving image data 150 and the ARI file 140 may be generated by using a different method from those illustrated with reference to FIGS. 1 through 3.

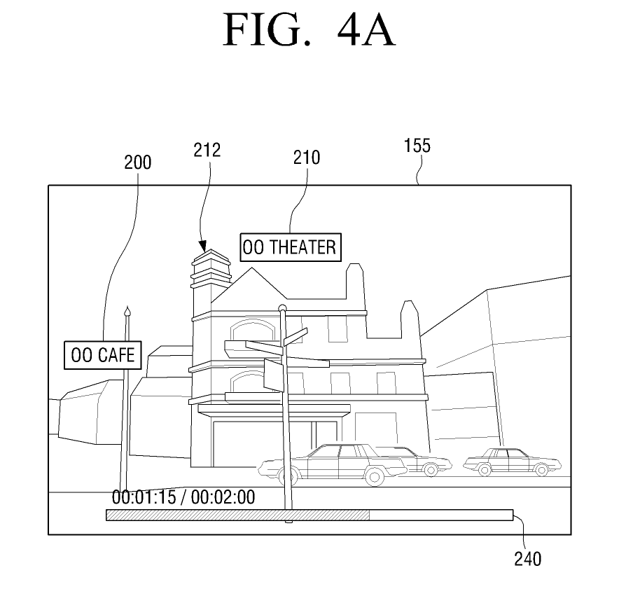

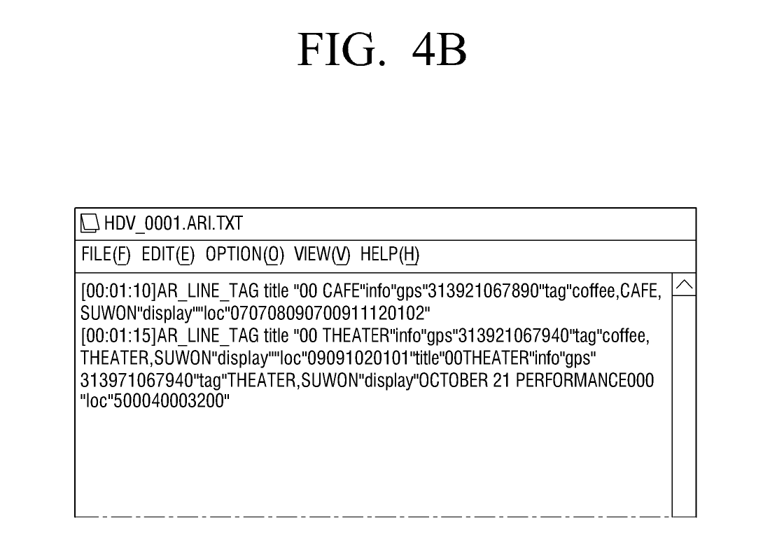

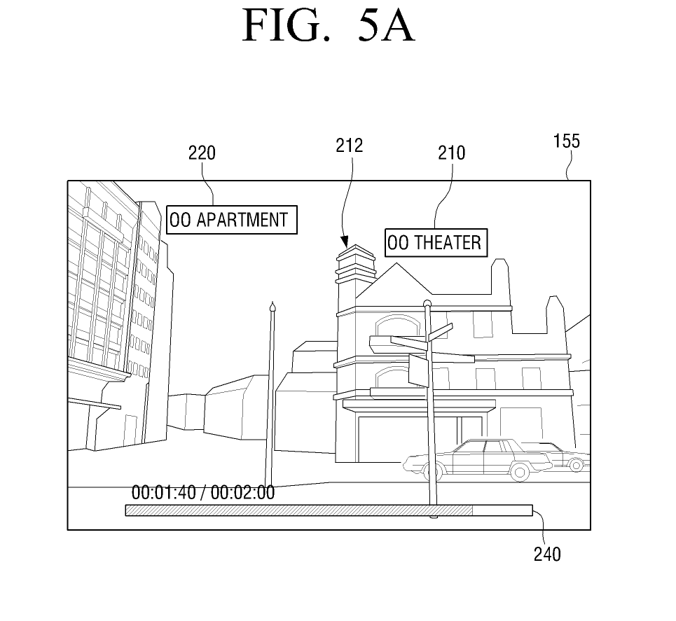

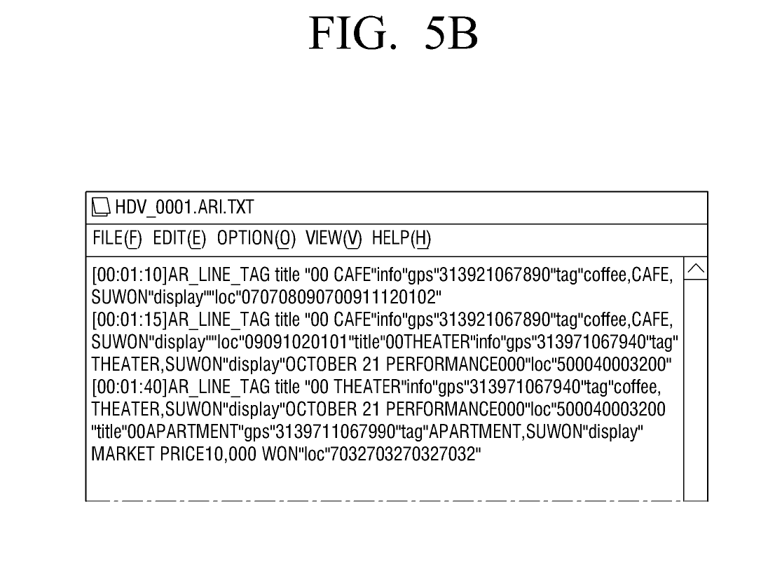

FIGS. 4A and 4B, and 5A and 5B illustrate methods of generating moving image data according to exemplary embodiments. As shown in FIG. 4A, if a user records an image being captured, virtual objects 200, 210 overlap a real image 212 and then are displayed on a display unit 155. In FIG. 4A, names of buildings seen on the real image 212 overlap with the buildings. Information regarding the names of the buildings may be generated by combining location information using a GPS, information received through a network and/or pre-stored information.

In FIG. 4A, a virtual object named “cafe” 200 overlaps with a left building of the real image 212 which is being captured, and a virtual object named “theater” 210 overlaps with a right building of the real image 212. Also, the virtual objects 200, 210 include ARI, and the ARI is generated as an ARI file 140. The generated ARI file 140 is shown in FIG. 4B. In other words, since the ARI file 140 includes “cafe and Suwon” or “theater and Suwon,” business type information and area information regarding the corresponding building are known. A duration bar 240, which indicates a current capturing time, is further displayed on a lower part of the display unit 155.

FIGS. 5A and 5B illustrate a moving image which is captured at a time point when 25 seconds have passed from the capturing time of FIG. 4A. In other words, as seen from a duration bar 240 of FIG. 5A, the moving image of FIG. 5A is captured at the time point when 25 seconds has passed in comparison with the image of FIG. 4A. When an object of FIG. 5A is captured, another building is shown. Therefore, a virtual object named “apartment” 220 is further included. Also, as shown in FIG. 5B, ARI further includes business type information and area information such as “apartment and Suwon.” In other words, ARI may be added at fixed time intervals, e.g., every 1 second, and if capturing is ended, finally accumulated pieces of ARI may be generated as an ARI file 140.

If information regarding objects, i.e., subjects, included in a moving image is accumulated to a time point when capturing of the moving image is ended to generate an ARI file 140, the ARI file 140 is executed together when reproducing a captured moving image, thereby accessing related detailed information. In this case, a file name of the ARI file 140 may be equal to that of moving image data 150. The ARI file 140 may be inserted into the moving image data 150.

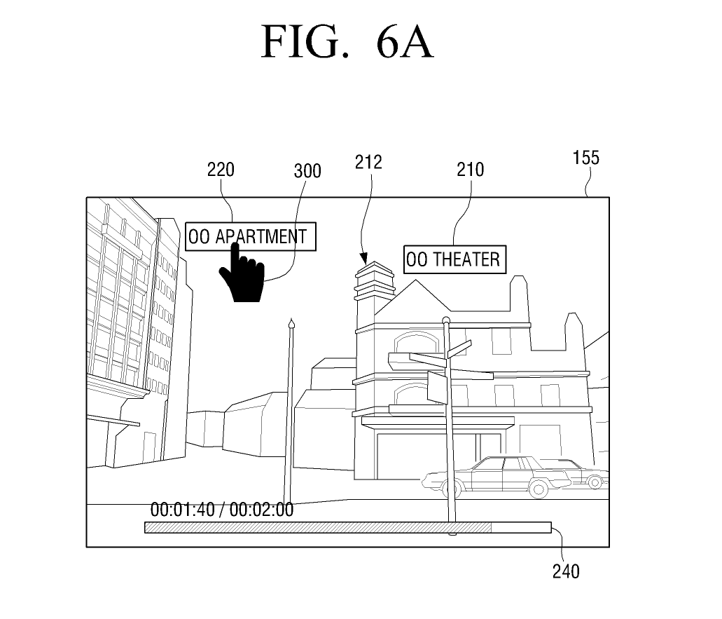

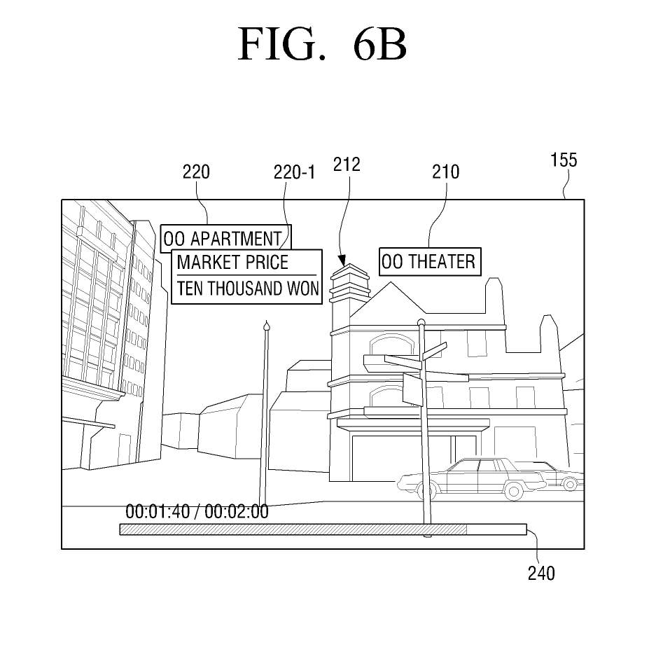

FIGS. 6A and 6B are views illustrating a method of reproducing moving image data 150 according to an exemplary embodiment.

As shown in FIG. 6A, a user 300 selects a virtual object 210 and/or 220 displayed on an image which is currently displayed. If a display unit 155 functions as a touch pad and/or touch screen, the user 300 touches the virtual object 210 and/or 220 to select the virtual object 210 and/or 220. If the display unit 155 is manipulated through a mouse, the user 300 clicks the virtual object 210 and/or 220 to select the virtual object 210 and/or 220. Since moving image data which is currently displayed includes ARI, the user 300 selects a virtual object 210, 220 to be provided with information corresponding to the selected virtual object 210, 220.

In other words, as shown in FIG. 6B, if the user 300 touches “apartment” 220, the user 300 is provided with detailed information 220-1 regarding the “apartment” 220. In FIG. 6B, detailed information, for example, the current market price 220-1 of the “apartment” 220 is displayed on the display unit 155. As described above, since moving image data 150 recorded by using an AR function includes ARI, the user 300 is provided with detailed information 220-1 regarding objects, i.e., subjects, which are displayed even when reproducing the moving image data 150.

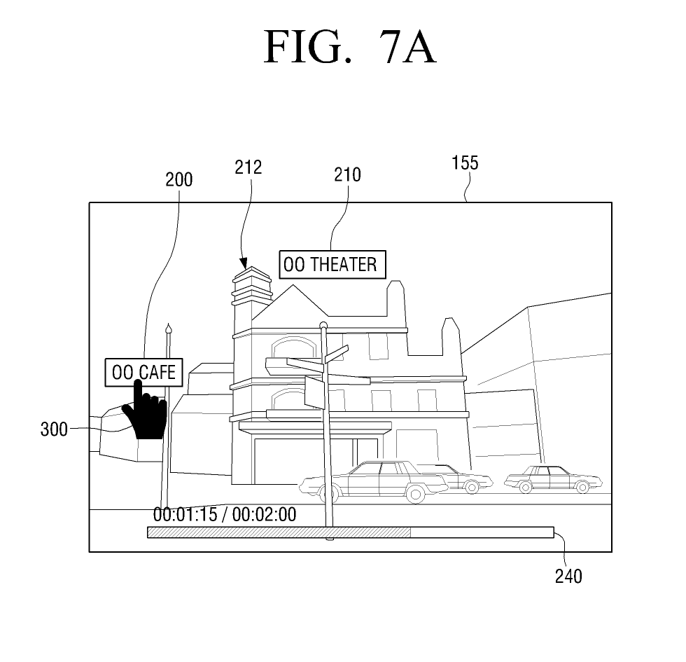

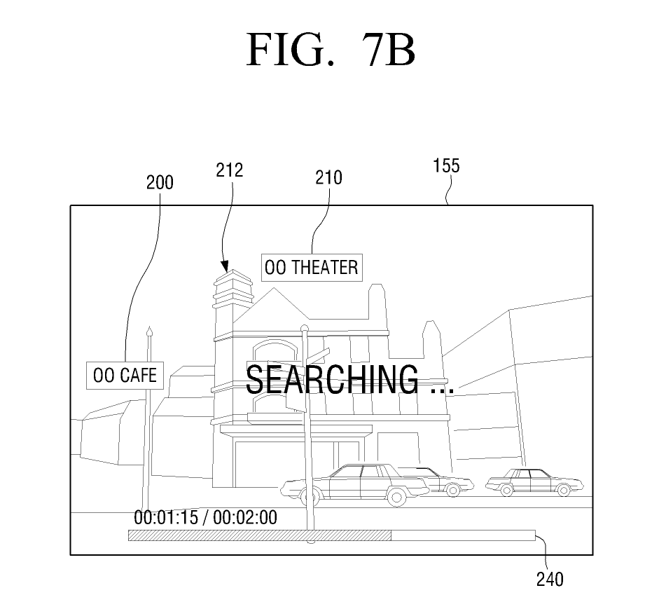

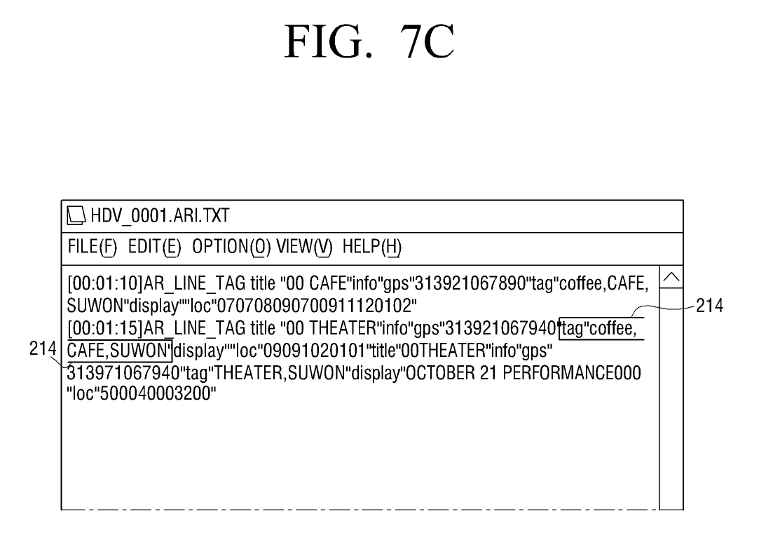

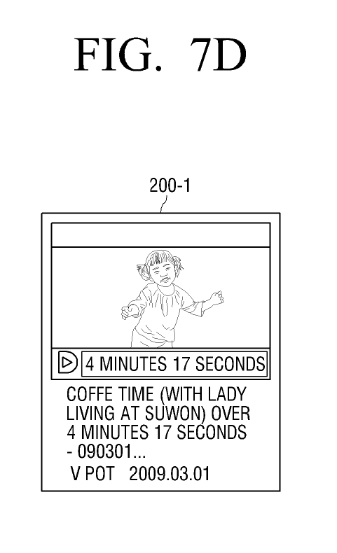

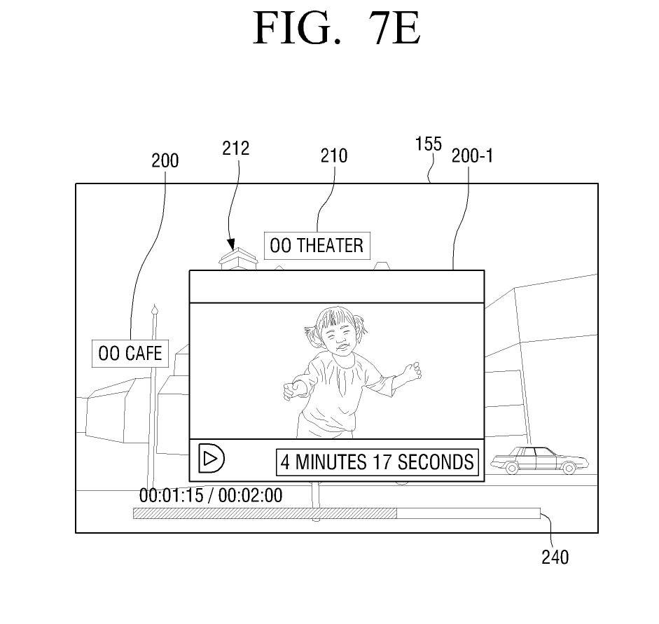

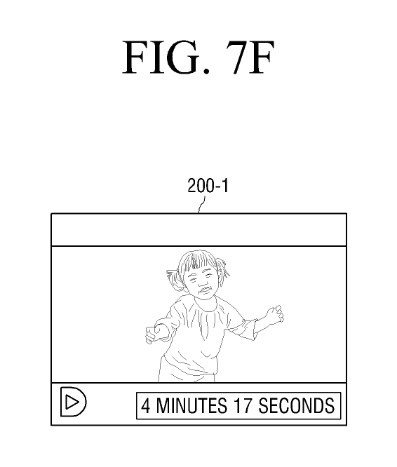

FIGS. 7A through 7F are views illustrating a method of reproducing moving image data 150 according to another exemplary embodiment. Differently from the exemplary embodiment of FIGS. 6A and 6B, the exemplary embodiment of FIGS. 7A through 7F illustrates a method of searching for information corresponding to a virtual object selected by a user on a network and then providing the searched information to the user.

In more detail, as shown in FIGS. 7A and 7B, if the user touches and selects “cafe” 200 among the virtual objects 200, 210, the user searches for detailed information regarding the “cafe” 200 shown in the real image 212 by using tag information included in an ARI file 140.

FIG. 7C illustrates ARI which is used if the user touches and selects the “cafe” 200 among the virtual objects 200, 210. As shown in FIG. 7D, a moving image 200-1 related to the “cafe” 200 shown in the real image 212 is searched and provided to the user through tag information 214 marked with a rectangle of FIG. 7C, i.e., business type information “cafe” and area information “Suwon.” The user clicks information regarding the moving image 200-1 to access the moving image 200-1 linked to the information.

Differently from this, as shown in FIG. 7E, moving image data 150 which is currently reproduced may be paused, and then the moving image 200-1 linked to the moving image data 150 may be displayed as a picture-in-picture (PIP) image. As shown in FIG. 7F, the moving image data 150 which is currently reproduced may be ended, and then only the moving image 200-1 linked to the moving image data 150 may be displayed to a full screen.

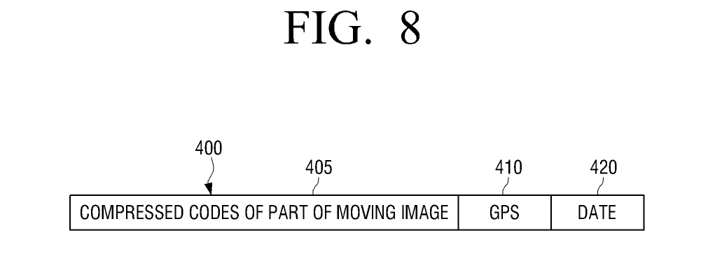

FIG. 8 is a view illustrating a format of an ID to maintain an identity of moving image data 150 when recording the moving image data 150, according to an exemplary embodiment. ARI may include the ID of the moving image data 150.

According to the format in which the ARI further includes the ID of the moving image data 150, it is possible to search for information related to a captured image.

In the ID information 400 generally indicated in FIG. 8, codes 405 of a compressed part of a moving image, GPS information 410, and a date 420 at which the moving image has been captured are recorded as tag information 214. The ID information 400 is included in the ARI to maintain the identity of the captured moving image. The format of FIG. 8 is only an example of a format of ID information 400 and is not limited thereto. Differently from this, those skilled in the art may combine a plurality of pieces of information regarding a moving image to constitute ID information 400.

The ID information 400 may be generated through arbitrary combinations of GPS coordinates, G sensor information, temperature information, user-defined information, a date at which an image has been acquired, and general information regarding the image.

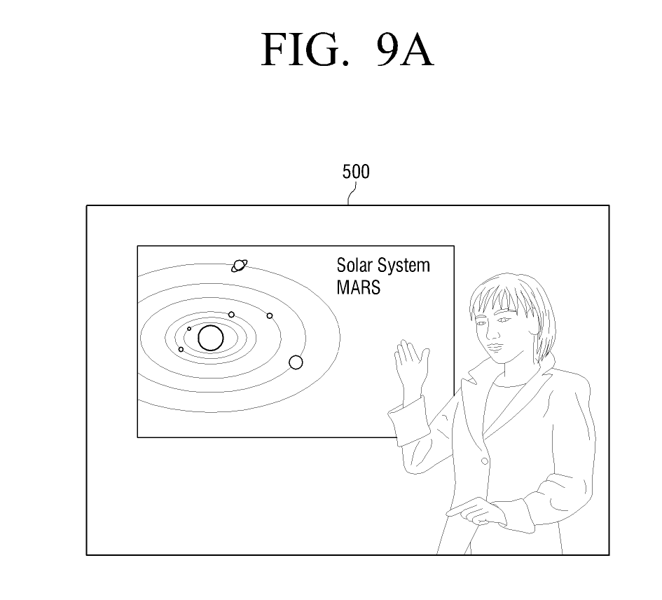

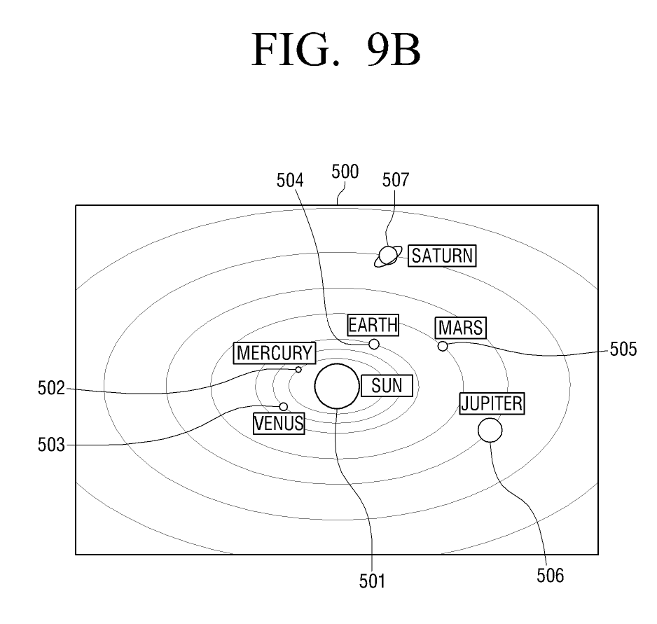

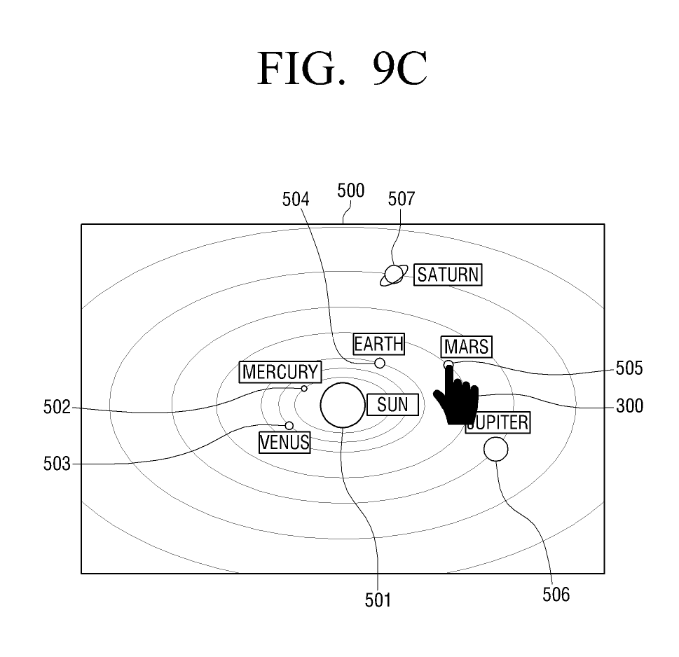

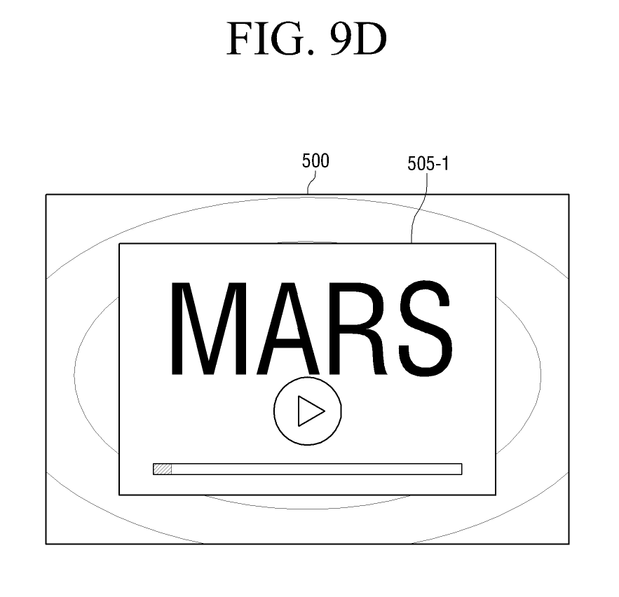

FIGS. 9A through 9D illustrate a method of generating and reproducing moving image data according to another exemplary embodiment. In at least one exemplary embodiment, a user directly generates an ARI file 140 by using the method illustrated with reference to FIG. 3.

FIG. 9A illustrates a scene capturing a moving image lecture 500 about planets of a solar system. If a moving image is completely captured and then is reproduced later, ARI related to virtual objects which will overlap with a screen and then will be displayed on the screen is generated and inserted into moving image data 150. A user may generate the ARI in a tag format and may insert the ARI into the captured moving image data 150.

FIG. 9B illustrates a case where an ARI file generated by a user is reproduced together with moving image data or the moving image data including the ARI is reproduced. As shown in FIG. 9B, virtual objects are respectively displayed beside planets with displaying an image of a planetary system.

As shown in FIG. 9C, a user 300 selects one of virtual objects. The user 300 touches a display unit 155 to select the virtual object in FIG. 9C but may click the virtual object through a mouse to select the virtual object.

FIG. 9D illustrates a screen on which the user 300 touches a virtual object 505 (i.e., object 505 corresponding to Mars shown in FIG. 9C) to display detailed information 505-1 based on ARI that is linked to the virtual object 505. The detailed information 505-1 may include, but is not limited to, text, hyperlinks, still images, moving images and sound. Referring to FIGS. 9C and 9D for example, since ARI included in the virtual object 505 related to the Mars is linked to an image of the Mars, the image of the linked Mars 505-1 is displayed in response to selecting the virtual object 505 by the user 300. Here, the image of Mars 505-1 is displayed as a picture-in-picture (PIP) form but may be displayed to as a full screen form.

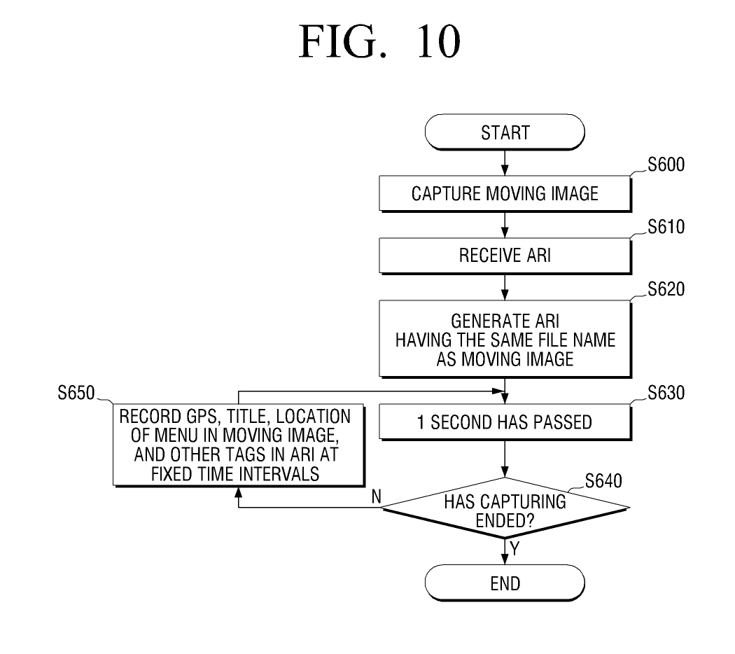

FIG. 10 is a flowchart illustrating a method of generating moving image data according to an exemplary embodiment. Referring to FIG. 10, when an operation of capturing a moving image begins (S600), moving image data 150 which is captured is received. ARI is received (S610). Here, the ARI is received through a GPS, a G sensor, a network, or the like as described above. The received ARI is generated as an ARI file 140 having the same file name as the captured moving image (S620). If capturing has not been ended (S640-N) after a preset time has passed (S630), a GPS, a title, a location of a menu in a moving image, and other tags are recorded in the ARI (S650). A determination is made as to whether the preset time has passed (S630), and the step (S640) of determining whether the capturing has been ended (S640) are performed again. While the moving image is completely captured through these processes, the ARI is accumulated at fixed time intervals to record the ARI file 140. The generated ARI file 140 may exist as a separate file or may be inserted into moving image data.

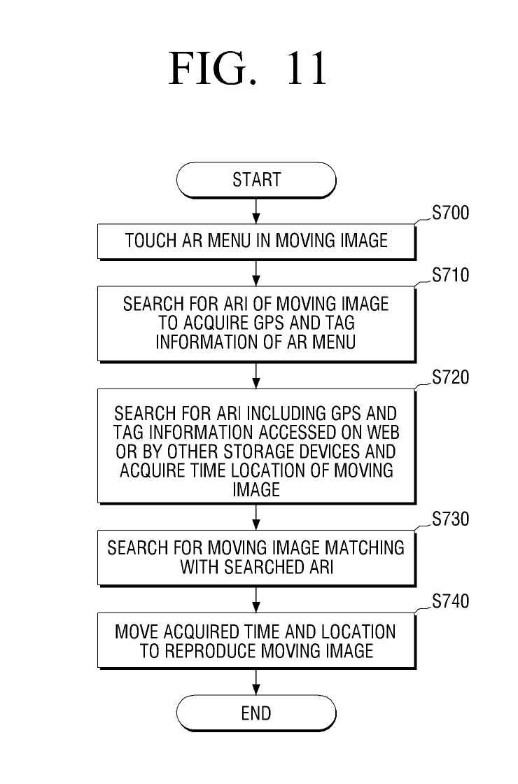

FIG. 11 is a flowchart illustrating a method of reproducing moving image data according to an exemplary embodiment. An AR menu in a moving image is touched (S700). An ARI file 140 of the moving image is searched to acquire GPS information and/or tag information of the AR menu (S710). Based on the acquired GPS and/or tag information, ARI including GPS information and/or tag information is searched from a network and/or other storage devices, and a location and the like of the moving image are acquired (S720). A moving image matching with the searched ARI is searched (S730). The moving image is reproduced using the acquired GPS and/or tag information (S740). The method of searching for another moving image by touching the AR menu has been described in FIG. 11. However, the present general inventive concept is not limited thereto but may be applied to a method of searching for text information related to a current moving image or still image information.

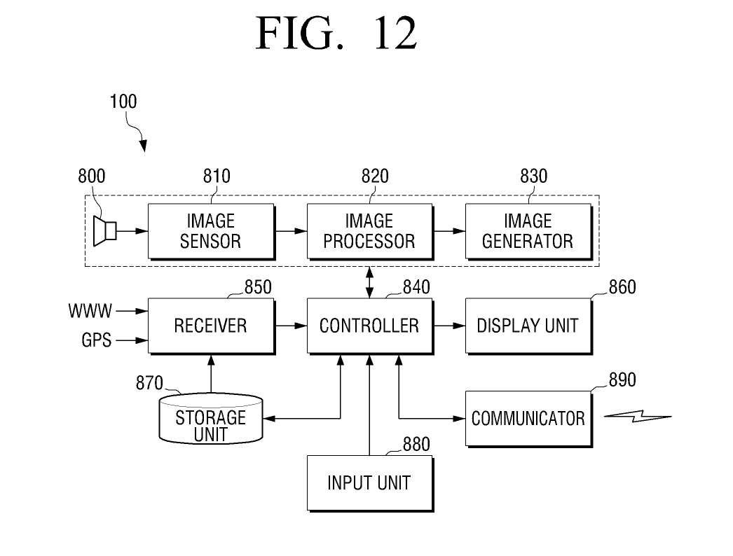

FIG. 12 is a block diagram illustrating a structure of a photographing apparatus according to an exemplary embodiment. Referring to FIG. 12, the photographing apparatus includes a photographing unit 800, an image sensor 810, an image processor 820, an image generator 830, a controller 840, a receiver 850, a display unit 860, a storage unit 870, an input unit 880, and a communicator 890.

The photographing unit 800 has a moving image photographing function and includes a lens (not shown), an aperture (not shown), etc.

The image sensor 810 converts a moving image received by the photographing unit 800 into an electric signal. The image sensor 810 may include, but is not limited to, a charge-coupled device (CCD) and a complementary metal oxide semiconductor (CMOS).

The image processor 820 processes moving image information received by the image sensor 810 in a format which is displayable on the display unit 860.

The controller 840 controls an overall operation of the photographing apparatus, in particular, records an image captured by the photographing unit 800 and simultaneously generates an ARI file 140 based on ARI received by the receiver 850. The controller 840 also inserts the ARI file 140 into captured moving image data 150. The controller 840 generates the ARI file 140 so that the ARI file 140 has the same file name as the captured moving image data 150.

The controller 840 controls the display unit 860 to search for the ARI file 140 having the same file name as the captured moving image data 150 to execute the ARI file 140 while displaying the captured moving image data 150.

The receiver 850 receives the ARI through a network or a GPS.

The display unit 860 displays information of the ARI file 140, together with the captured moving image data 150. If there is an input signal of a user through the input unit 880, the display unit 860 displays text information, still image information, and/or moving image information existing on the network based on the input signal.

The storage unit 870 stores the ARI file 140 generated by the controller 840 and the moving image data 150 captured by the photographing unit 800. The storage unit 870 may store the moving image data 150 into which the ARI file 140 has been inserted. The input unit 880 receives a request for information related to a moving image from the user. The controller 840 accesses related information based on information of the ARI file 140 and/or is connected to a linked website to display the related information through the display unit 860, based on the request of the user input from the input unit 880.

The communicator 890 is connected to an external device (not shown) by wireless and/or by wire. The communicator 890 transmits a file stored in the storage unit 870 to the outside or accesses a network or the like to receive information.

According to the above-described structure, an ARI file can be separately generated and/or can be inserted into moving image data. Therefore, even if recorded moving image data is reproduced, a user can be provided with detailed information related to the moving image data and/or can access related information.

Although various exemplary embodiments of the present general inventive concept have been illustrated and described, it will be appreciated by those skilled in the art that changes may be made in these exemplary embodiments without departing from the principles and spirit of the present general inventive concept, the scope of which is defined in the appended claims and their equivalents.

What is claimed is:

1. A method of generating moving image data, the method comprising:
capturing a moving image;
receiving augmented reality information (ARI) of the moving image; and
generating a file comprising the ARI while simultaneously recording the captured moving image.

2. The method as claimed in claim 1, further comprising inserting the file comprising the ARI into data of the captured moving image.

3. The method as claimed in claim 1, wherein the ARI is divided on a tag basis and is tag information which comprises information seen in an augmented reality (AR) and reproduction information necessary to reproduce the moving image data.

4. The method as claimed in claim 3, wherein the information seen in the AR comprises at least one of global positioning system (GPS) coordinates, gyro (G) sensor information, temperature information, user-defined information, a date at which the moving image has been acquired, and general information regarding the moving image, and the reproduction information comprises one of an area and a coordinate in which a reproducing apparatus is touchable when reproducing the moving image data.

5. The method as claimed in claim 3, wherein the ARI comprises identification (ID) information which is generated through arbitrary combinations of the GPS coordinates, the G sensor information, the temperature information, the user-defined information, the date at which the moving image has been acquired, and the general information regarding the moving image.

6. The method as claimed in claim 1, wherein the ARI is received at preset time intervals.

7. The method as claimed in claim 6, wherein web information related to detailed information comprises text information regarding the moving image, still image information, and moving image information.

8. The method as claimed in claim 1, wherein the ARI is received by wireless through a wireless network or by wire through a storage device which stores information related to the captured moving image.

9. The method as claimed in claim 1, wherein the file comprising the ARI is a file which is made and generated by a user.

10. The method as claimed in claim 1, wherein a file name of the file comprising the ARI is equal to a file name of the captured moving image data.

11. A method of reproducing moving image data, the method comprising:
searching for an ARI file comprising ARI of a moving image; and
executing the searched ARI file while simultaneously displaying the moving image data.

12. The method as claimed in claim 11, wherein the ARI is divided on a tag basis and is tag information which comprises information seen in an AR and reproduction information necessary to reproduce included with the moving image.

13. The method as claimed in claim 12, wherein the information seen in the AR comprises at least one of GPS coordinates, G sensor information, temperature information, user-defined information, a date at which the moving image has been acquired, and general information regarding the moving image, and the reproduction information comprises one of an area and a coordinate in which a reproducing apparatus is touchable when reproducing the moving image data.

14. The method as claimed in claim 11, wherein the ARI is information to search for detailed information of the moving image and is information to access web information related to the detailed information.

15. The method as claimed in claim 14, wherein the web information related to the detailed information comprises text information of the moving image, still image information, and moving image information.

16. The method as claimed in claim 11, wherein the moving image data into which the ARI has been inserted is received by wireless through a wireless network or by wire through a storage device.

17. The method as claimed in claim 11, wherein the display of the moving image data comprises overlapping and displaying the ARI with the moving image data through an On Screen Display (OSD).

18. The method as claimed in claim 11, further comprising receiving a request to access the detailed information of the moving image through the ARI from a user,
wherein if the request is received, the detailed information which is related to the moving image and exists on a website is accessed to be displayed to the user.

19. The method as claimed in claim 18, wherein the detailed information which is related to the moving image and accessed through the ARI is at least one of text information, still image information, and moving image information.

20. The method as claimed in claim 18, wherein if the request is received, reproduction of currently displayed moving image data is ended, and the detailed information which is accessed through the ARI and related to the moving image is displayed.

21. The method as claimed in claim 18, wherein if the request is received, reproduction of currently displayed moving image data is paused, and the accessed detailed information related to the moving image is displayed as a picture-in-picture (PIP) image.

22. A photographing apparatus comprising:
a photographing unit to capture a moving image;
a receiver to receive ARI of the moving image; and
a controller to generate a file comprising the ARI while simultaneously recording the captured moving image.

23. The photographing apparatus as claimed in claim 22, wherein the controller inserts the file comprising the ARI into data of the captured moving image to generate a file.

24. The photographing apparatus as claimed in claim 22, wherein the ARI is divided on a tag basis and is tag information which comprises information seen in an AR and reproduction information necessary to reproduce the moving image data.

25. The photographing apparatus as claimed in claim 24, wherein the information seen in the AR comprises at least one of GPS coordinates, G sensor information, temperature information, user-defined information, a date at which the moving image has been acquired, and general information regarding the moving image, and the reproduction information comprises one of an area and a coordinate in which a reproducing apparatus is touchable when reproducing the moving image data.

26. The photographing apparatus as claimed in claim 24, wherein the ARI comprises ID information which is generated through arbitrary combinations of the GPS coordinates, the G sensor information, the temperature information, the user-defined information, the date at which the moving image has been acquired, and the general information regarding the moving image.

27. The photographing apparatus as claimed in claim 22, wherein a file name of the file comprising the ARI is equal to a file name of the captured moving image data.

28. The photographing apparatus as claimed in claim 27, wherein web information related to detailed information comprises text information related to the moving image, still image information, and moving image information.

29. The photographing apparatus as claimed in claim 22, wherein the receiver receives the moving image data, into which the ARI is inserted, by wireless through a wireless network or by wire through a storage device.

30. The photographing apparatus as claimed claim 22, further comprising a display unit to execute and display an ARI file along with the moving image data.

31. The photographing apparatus as claimed in claim 30, wherein the display unit overlaps and displays the ARI with the moving image data through an OSD.

32. The photographing apparatus as claimed in claim 30, further comprising an input unit to receive a request for information related to the moving image from a user,
wherein if the request of the user is received from the input unit, the display unit accesses the detailed information, which is related to the moving image and exists on a website, to display the detailed information to the user.

33. The photographing apparatus as claimed in claim 32, wherein the input unit is a touch pad which is provided on the display unit.

34. The photographing apparatus as claimed in claim 32, wherein the detailed information which is related to the moving image and accessed through the ARI is at least one of text information, still image information, and moving image information.

35. The photographing apparatus as claimed in claim 32, wherein if the request of the user is received from the input unit, the display unit ends reproducing currently displayed moving image data and displays the detailed information which is accessed through the ARI and related to the moving image.

36. The photographing apparatus as claimed in claim 32, wherein if the request of the user is received from the input unit, the display unit pauses reproducing currently displayed moving image data and displays the accessed detailed information related to the moving image as a PIP image.

37. The photographing apparatus as claimed claim 22, wherein the photographing apparatus comprises one of a camera, camcorder, a smart phone, and a tablet personal computer (PC).

38. A photographing apparatus, comprising:
a display screen to display moving image data including a real image and at least one virtual object; and
a control module to generate and display detailed information of the real image in response to manipulating the at least one virtual object.

39. The photographing apparatus of claim 38, wherein the detailed information is based on ARI that is generated by a user and the control module embeds the ARI into the moving image data while displaying the moving image data.

40. The photographing apparatus of claim 38, wherein the detailed information includes text, hyperlinks, still images, moving images and sound.

41. A photographing apparatus, comprising:
a display screen to display moving image data thereon; and
a control module to read a data file comprising moving image data and ARI data and to reproduce the moving image data on the display screen along with at least one virtual object linked to a real image displayed in the moving image data,
wherein the control module displays detailed information based on the ARI data of the data file in response to selecting the virtual object.

42. The photographing apparatus of claim 40, further comprising a storage unit that stores the data file.

43. The photographing apparatus of claim 40, wherein the ARI data of the data file includes at least one tag indicating ARI of the real image linked to the virtual object.

44. The photographing apparatus of claim 40, wherein the ARI data is generated based on ARI received over a network.

45. The photographing apparatus of claim 41, wherein the ARI data is generated based on first data determined during capturing moving images displayed in the moving image data and second data stored in the storage unit.

46. The photographing apparatus of claim 40, wherein the ARI data is generated based on input data from a user of the photographing apparatus.

47. A photographing apparatus, comprising:
a photographing unit to record a captured moving image;
a storage unit to store first information; and
a controller to determine second information from the capture moving image, to generate a combined ARI based on the first information stored in the storage unit and the second information from the captured moving image, and to generate a data file comprising the combined ARI while recording the captured moving image.
